(19) United States
(12) Patent Application Publication
(10) Pub. No.: US 2024/0126229 A1
(43) Pub. Date: Apr. 18, 2024

(54) COOLING SYSTEM PERFORMANCE EARLY WARNING METHOD BASED ON DICTIONARY LEARNING

(71) Applicant: ZHEJIANG ERG TECHNOLOGY JOINT STOCK CO., LTD, Zhejiang (CN)

(72) Inventors: Dianhui WANG, Taizhou (CN); Shirong ZHANG, Taizhou (CN); Peng ZHANG, Taizhou (CN); Wangyang WANG, Taizhou (CN); Jie WANG, Taizhou (CN); Yue FANG, Taizhou (CN); Linfeng GU, Taizhou (CN)

(21) Appl. No.: 17/642,962

(22) PCT Filed: Jan. 22, 2022
(86) PCT No.: PCT/CN2022/073325

§ 371 Date: May 11, 2023

(30) Foreign Application Priority Data
Nov. 2, 2021 (CN) 202111285508.7

(51) Int. Cl. G05B 19/05

(52) U.S. Cl. CPC G05B 19/058; G05B 2219/13183

(57) ABSTRACT

A cooling system performance early warning method based on dictionary learning is disclosed. A sensor and an oil pump frequency converter are arranged on a cooler of the cooling system to measure operation data of the cooling system. A PLC controller is installed on the cooler to collect the measured operation data and connected with a cloud server, and the cloud server first performs offline dictionary learning on the data, so as to establish a performance cads warning model for each group of coolers respectively. After the offline dictionary learning stage is completed, an online early warning stage is entered, and the established performance early warning model is used to carry out a real-time performance early warning of the cooling system. The early warning method can use the established performance early warning model to carry out real-time performance early warning, which has the advantages of real-time, realizability and strong pertinence.

### CROSS REFERENCE TO RELATED APPLICATION

This patent application claims the benefit and priority of Chinese Patent Application No. 202111285508.7 filed on Nov. 2, 2021, the disclosure of which is incorporated by reference herein in its entirety as part of the present application.

### TECHNICAL FIELD

The present disclosure relates to the technical field of performance early warning, and more specifically, to a cooling system performance early warning method based on dictionary learning.

### BACKGROUND ART

Forced oil circulating water cooling system takes water as the cooling medium. It has the characteristics of small volume, high cooling efficiency, convenient installation and simplified pipeline system. It can effectively reduce the actual floor area of transformer and has been widely used in power transformer. The forced oil circulating water cooling system includes oil side pipeline, water side pipeline, oil pump, water valve, cooler pipe and other components. In the literature, there are many studies on the design of heat exchanger, operation and maintenance, control system design and implementation of forced oil circulating water cooling system, but there are few research reports on the performance early warning of cooling system. The cooling water supply modes of forced oil circulating water cooling system mainly include: direct cooling system, semi closed system and fully closed system. In direct cooling and semi closed systems, the water quality of circulating cooling system will deteriorate after long-term operation, which is easy to cause scale deposit and corrosion on the water side, further lead to cooler failure, equipment shutdown and even major economic losses. The current maintenance strategy generally makes the cooler maintenance plan or replaces the equipment according to the operation time. The recommended time adopted is the fixed reference value preset by the manufacturer, and the operating conditions of each cooling system are not effectively considered. Regular maintenance and regular replacement of equipment will bring problems. In the case of poor water quality, maintenance according to the preset recommended time will bring the risk of failure. When the water quality is good, it will bring unnecessary maintenance or waste of equipment life cycle. In view of the above problems, this disclosure provides a cooling system performance early warning method based on dictionary learning, which carries out real-time early warning when the performance of the cooler deteriorates.

### SUMMARY

In view of the above problems existing in the prior art, the disclosure provides a cooling system performance early warning method based on dictionary learning. The early warning method can use the established performance early warning model to carry out real-time performance early warning of the cooling system. The early warning method has the advantages of real-time, realizability and strong pertinence.

The technical scheme of the disclosure is as follows.

A cooling system performance early warning method based on dictionary learning is provided. A sensor and an oil pump frequency converter are arranged on a cooler of the cooling system, and the sensor and the oil pump frequency converter are used to measure an operation data of the cooling system. A PLC controller is installed on the cooler to collect the measured operation data. The PLC controller is connected with a cloud server, and the cloud server first performs offline dictionary learning on the data, so as to establish a performance early warning model for each group of coolers respectively. After the offline dictionary learning stage is completed, an online early warning stage is entered, and the established performance early warning model is used to carry out a real-time performance early warning of the cooling system.

The cooling system performance early warning method based on dictionary learning provided by the disclosure can timely find the performance deterioration of the coolers and give early warning, so as to timely carry out manual intervention and reduce the failure risk. At the same time, the early warning method does not need the learning samples in the fault state. It can realize dictionary modeling and online early warning only by learning the normal working condition data. The sample obtaining is convenient, the modeling is easy, and the early warning method is easy to realize. Based on the dictionary learning method, the performance early warning model is established through the learning of normal working condition data, which has stronger pertinence.

Preferably, in the aforementioned cooling system performance early warning method based on dictionary learning, the operation data includes a temperature, a pressure and a flow of the cooler and an output frequency f, of the oil pump frequency converter. When the forced oil circulating water cooling system of transformer operates, it is necessary to obtain the necessary operation status in real time, mainly including oil side temperature, pressure, flow and water side temperature, pressure, flow and other parameters. At the same time, the oil pump of each group of coolers is equipped with frequency converter to control the oil pump speed in real time. The output frequency fᵢ of the oil pump frequency converter also needs to be considered when monitoring the cooling performance.

Preferably, in the aforementioned cooling system performance early warning method based on dictionary learning, the offline dictionary learning stage includes the following steps.

LS1: setting a cooler group number i=1. Since there are multiple groups of coolers in the transformer cooling system, the performance early warning model of each group of coolers needs to be established respectively, so the circulation method is used to deal with multiple groups of coolers respectively.

LS2: selecting the operation data of sᵢ=1 from a database. sᵢ=0 indicates that the cooler is in shutdown state, and sᵢ=1 indicates that the cooler is in operation state.

LS3: selecting data from the data obtained in step LS2 to form a learning sample matrix {xᵢ^{k}}ₖ₌₁^{N}^{₁}.

LS4: setting dictionary learning parameters, selecting an initial dictionary, starting offline dictionary learning, and obtaining dictionary matrix Dᵢ and coding matrix Sᵢ.

LS5: calculating a sample reconstruction error RE₁^{k} of cooler group i according to REᵢ^{k}=∥xᵢ^{k}−Dsₖ∥₂ after obtaining the dictionary matrix Dᵢ and the coding matrix Sᵢ, and then calculating a reconstruction error limit limitᵢ.

LS6: saving a dictionary learning result of the cooler group i.

LS7: adding a cooler group number and turning to LS2 to start a learning and modeling of a next group of coolers, and

exiting the offline dictionary learning process after all cooler groups are learned.

Preferably, in the aforementioned cooling system performance early warning method based on dictionary learning, operating conditions of cooler group i need to be fully covered when selecting samples, and a sample collection capacity is greater than or equal to 500.

Preferably, in the aforementioned cooling system performance early warning method based on dictionary learning, the offline dictionary learning includes two steps: sparse coding and dictionary updating, and the two steps adopt OMP algorithm and KSVD algorithm respectively.

Preferably, in the aforementioned cooling system performance early warning method based on dictionary learning, the reconstruction error limit limit, is calculated by using a kernel density estimation method.

Preferably, in the aforementioned cooling system performance early warning method based on dictionary learning, after the offline dictionary learning stage is completed, it can be transferred to the online early warning stage. When the cloud server obtains the real-time operation data of the cooling system from the PLC controller, an online early warning function is called. The online early warning stage is divided into following steps.

AS1: setting cooler group number i=1. Because there are multiple groups of coolers, similar to the learning stage, the online early warning also adopts circulation to deal with multiple groups of coolers.

AS2: taking out the real-time operation data of the cooling system from a real-time database to judge whether the cooler group i is in operation, and skipping the processing of the cooler group i if the cooler group i is not in operation.

AS3: selecting an operation data of sᵢ=1 from the real-time database if the cooler group i is in operation.

AS4: constituting a real-time sample xᵢ^{r} used to characterize a state of the cooler group i and for subsequent cooler performance monitoring and early warning.

AS5: calling the dictionary matrix Dᵢ saved in the learning stage, and calculating a coding vector 5,' used the OMP algorithm, wherein

$${s}_{i}^{r} = {arg min}_{{s}_{i}^{r}} {‖ {x}_{i}^{r} - {D}_{i} {s}_{i}^{r} ‖}_{2} .$$

AS6: calculating a reconstruction error REᵢ^{r} of the real-time sample xᵢ^{r} from the coding vector and the dictionary matrix Dᵢ, where REᵢ^{r}=∥xᵢ^{r}−Dᵢsᵢ^{r}∥₂.

AS7: judging a relationship between the reconstruction error REᵢ^{r} and the reconstruction error limit limitᵢ.

AS8: indicating that a performance of cooler group i is degraded and needing early warning if the reconstruction error REᵢ^{r} of continuous sampling is greater than the reconstruction error limit limit, and giving no warning if the reconstruction error limit of continuous sampling is less than or equal to the reconstruction error limit limit.

AS9: adding the cooler group number and going to step AS2 to start an early warning processing of the next group of coolers, and

exiting a block of the online early warning function when all cooler groups of the cooler system are processed, and calling the online early warning function again to complete the real-time performance early warning of the cooling system after a next sampling arrives and is stored in the real-time database.

Preferably, in the aforementioned cooling system performance early warning method based on dictionary learning, when judging the relationship between reconstruction error REᵢ^{r} and reconstruction error limit limitᵢ, an early warning coefficient C_{Ai}is defined:

C_{Ai}=(REᵢ^{r-w}>limitᵢ)&, . . . ,&(REᵢ^{r-1}>limitᵢ)&,&(REᵢ^{r}>limitᵢ)

Where, w is a window width of performance warning. When the reconstruction error REᵢ^{r} of continuous w real-time samples is greater than the reconstruction error limit limit,, that is, when C_{Ai} is True, performance warning will be carried out, and when C_{Ai} is False, performance warning will not be carried out.

Preferably, in the aforementioned cooling system performance early warning method based on dictionary learning, the cloud server is connected with the PLC controller through a NB- loT module, and after the NB-loT module obtains the sensor reading from the PLC controller, the NB-loT module packages and sends the data to the cloud background through MQQT protocol. The cloud server can make full use of the advantages of cloud computing. With the computing flexibility and expansion ability of cloud computing platform, it can obtain big data support to strengthen the early warning performance of dictionary learning algorithm.

Preferably, in the aforementioned cooling system performance early warning method based on dictionary learning, the cloud server constructs a service management layer of the Internet of things to complete data storage, management, performance calculation and in-depth analysis. And front-end software such as web page, APP and WeChat applet is a comprehensive application layer of the Internet of things system to complete system management and realize man-machine interface. The use of NB-IoT Internet of things system will provide remote monitoring and remote-control functions for the cooler system, and the introduction of multi platform of front-end web page, APP and WeChat applet will provide customers with more convenient use.

### BRIEF DESCRIPTION OF THE DRAWINGS

FIG. 1 is a cloud deployment diagram of the cooling system performance early warning system.

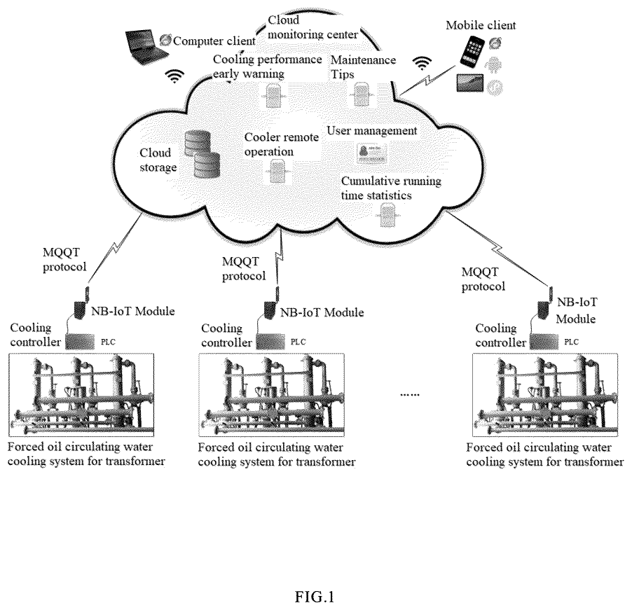

FIG. 2 is the layout diagram of the cooling system and measuring points.

FIG. 3 is the flow chart of the cooling system performance early warning.

### DETAILED DESCRIPTION OF THE EMBODIMENTS

The disclosure is further described below in combination with the accompanying drawings and specific implementation mode (including embodiments), but it is not used as a basis for limiting the disclosure.

### Embodiment

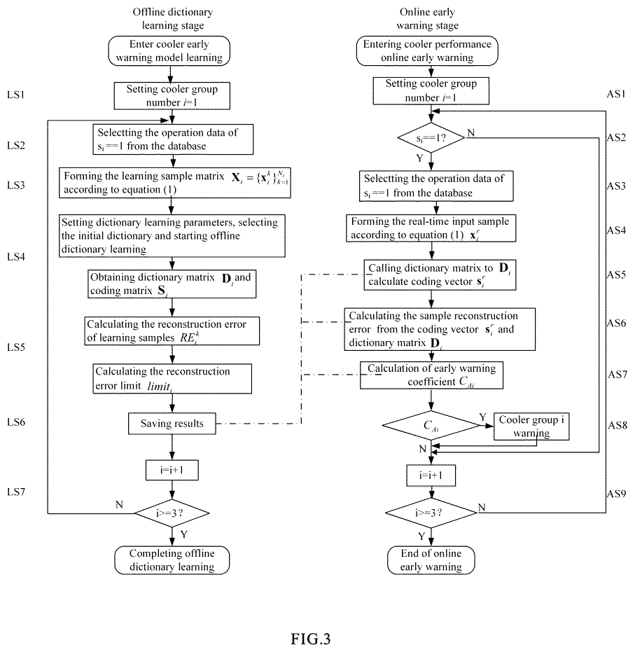

Refer to FIG. I to FIG. 3, a cooling system performance early warning method based on dictionary learning is provided. A PLC controller is installed on the cooler to collect the measured operation data. The cloud server is connected to the PLC controller through the NB-IoT module. After the NB-IoT module obtains the sensor reading from the PLC controller, it packages and sends the data to the cloud background through MQQT protocol. The cloud server first learns the offline dictionary of these data, so as to establish a performance early warning model for each group of coolers. After the offline dictionary learning stage is completed, it will enter the online early warning stage, and the established performance early warning model is used to carry out real-time performance early warning of the cooling system. It includes the following stages.

(1) Cooler state obtaining

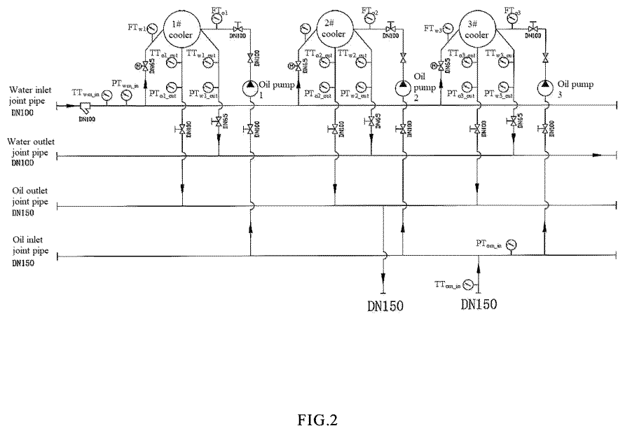

As shown in FIG. 2, sensors are arranged on three groups of coolers of the cooling system. The sensors are used to measure the operation data of the coolers during operation, mainly including the temperature, pressure and flow on the oil side and the temperature, pressure and flow parameters on the water side. Table 1 lists the sensor measuring points on the three groups of coolers of the cooling system. At the same time, the oil pump of each group of coolers is equipped with frequency converter to control the oil pump speed in real time. The output frequency fᵢ of the oil pump frequency converter should also be considered when monitoring the cooling performance.

TABLE 1
Measuring point table of forced oil circulating water cooling system

| Name of | | Name of | |
|---|---|---|---|
| measuring | Description of measuring | measuring | Description of Measuring |
| point | point | point | point |
| PTₒₘ_{_{—}}ᵢₙ | Oil inlet pressure of main | PTₒ₂_{_{—}}ₒᵤₜ | Oil outlet pressure of 2# |
| | pipe | | cooler |
| TTₒₘ_{_{—}}ᵢₙ | Oil inlet temperature of main | TT_{w2}_{_{—}}ₒᵤₜ | Water outlet temperature of |
| | pipe | | 2# cooler |
| TT_{wm}_{_{—}}ᵢₙ | Water inlet pressure of main | PT_{w2}_{_{—}}ₒᵤₜ | Water outlet pressure of 2# |
| | pipe | | cooler |
| PT_{wm}_{_{—}}ᵢₙ | Water inlet temperature of | FTₒ₂ | Oil flow of 2# cooler |
| | main pipe | | |
| TTₒₗ_{_{—}}ₒᵤₜ | Oil outlet temperature of 1# | FT_{w2} | Water flow of 2# cooler |
| | cooler | | |
| PTₒₗ_{_{—}}ₒᵤₜ | Oil outlet pressure of 1# | TTₒ₃_{_{—}}ₒᵤₜ | Oil outlet temperature of |
| | cooler | | 3# cooler |
| TTw₁_{_{—}}ₒᵤₜ | Water outlet temperature of | PTₒ₃_{_{—}}ₒᵤₜ | Oil outlet pressure of 3# |
| | 1# cooler | | cooler |
| PT_{w1}_{_{—}}ₒᵤₜ | Water outlet pressure of 1# | TT_{w3}_{_{—}}ₒᵤₜ | Water outlet temperature of |
| | cooler | | 3# cooler |
| FTₒₗ | Oil flow of 1# cooler | PT_{w3}_{_{—}}ₒᵤₜ | Water outlet pressure of 3# |
| | | | cooler |
| FT_{w1} | Water flow of 1# cooler | FTₒ₃ | Oil flow of 3# cooler |
| TTₒ₂_{_{—}}ₒᵤₜ | Oil outlet temperature of 2# | FT_{w3} | Water flow of 3# cooler |
| | cooler | | |

In order to adapt to the grouping operation characteristics of the cooling system, the performance early warning models of the three groups of coolers are established respectively, and the input vectors of the model need to be constructed accordingly. Taking the three groups of coolers shown in FIG. 2 as an example, the input vectors of cooler group 1, cooler group 2 and cooler group 3 are shown as follows:

x₁=(PT_{om_in},TT_{om_in},TT_{wm_in},PT_{wm_in},TT_{o1_out},PT_{o1_out},TT_{w1_out},PT_{w1_out},FTₒ₁,FT_{w1},f₁)

x₂=(PT_{om_in},TT_{om_in},TT_{wm_in},PT_{wm_in},TT_{o2_out},PT_{o2_out},TT_{w2_out},PT_{w2_out},FTₒ₂,FT_{w1},f₂)

x₃=(PT_{om_in},TT_{om_in},TT_{wm_in},PT_{wm_in},TT_{o3_out},PT_{o3_out},TT_{w3_out},PT_{w3_out},FTₒ₃,FT_{w1},f₃)

After obtaining the input vectors of the cooler groups, the learning sample matrix Xᵢ of the cooler group i can be established, where Xᵢ ∈ R^{11×N}^{ᵢ}, 11 represents the number of variables of cooler group i and Nᵢ is the number of learning samples of cooler group i.

(2) Offline dictionary learning stage

The Offline dictionary learning stage includes the following steps.

LS1: A cooler group number i=1 is set. Since there are three groups of coolers in the transformer cooling system, the performance early warning model of each group of coolers needs to be established respectively, so the circulation method is used to deal with multiple groups of coolers respectively.

LS2: The operation data of sᵢ=1 is selected from a database, wherein sᵢ=0 indicates that the cooler is in shutdown state, and sᵢ=1 indicates that the cooler is in operation state.

LS3: Data from the data obtained in step LS2 is selected to form a learning sample matrix {xᵢ^{k}}ₖ₌₁^{N}^{₁}. When selecting samples, it is necessary to fully cover the operating conditions of cooler group i, and the sample collection capacity is 500.

LS4: After the cloud obtains a large number of operation data of the cooling system, the sample set of sᵢ=1 is selected to form the sample set {xᵢ^{k}}ₖ₌₁^{N}^{₁} for the training and learning of cooler group 1, the sample set {x₃^{k}}ₖ₌₁^{N}^{₃} of s₂=1 is selected for cooler group 2, and the sample set {x₃^{k}}ₖ₌₁^{N}^{₃} of s₃=1 is selected for the training and learning of cooler group 3. Where N₁, N₂ and N₃ respectively represent the capacity of three groups of cooler training sample sets, and the sample collection capacity is 500. After obtaining the learning sample set {xᵢ^{k}}ₖ₌₁^{N}^{₁} of cooler group i, the offline dictionary learning process can be entered. The optimization goal of the dictionary learning algorithm model is to minimize the sample reconstruction error. The dictionary learning algorithm model is as follows:

$$〈 {D}_{i} , {S}_{i} 〉 = {arg min}_{{D}_{i} , {S}_{i}} {‖ {X}_{i} - {D}_{i} {S}_{i} ‖}_{F}^{2} ; s . t . {‖ {s}_{k} ‖}_{0} \leq L .$$

Where Xᵢ is the learning sample matrix of cooler group i. Dᵢ is the dictionary matrix, Dᵢ=[d₂,d₂, . . . ,d_{K}] ∈R^{11×K}, and the dimension of the dictionary matrix is 11, which is equal to the number of variables in the learning sample matrix, and K is the number of dictionary atoms. Sᵢ is the

Kx;V coding matrix, Sᵢ=[s₁,s₂, . . . ,s_{N}_{ᵢ}] ∈ R^{K×N}^{ᵢ}, and Xᵢ≈DᵢSᵢ. ∥Xᵢ−DᵢSᵢ∥_{F}² represents the sample reconstruction error, L represents the sparsity, which represents the number of non-zero elements in each column of the coding matrix, and is also the number of dictionary atoms used in the sparse representation of samples. The dictionary learning algorithm model shows that the learning process of the cooler performance early warning model is to minimize the second norm of the matrix of the product difference between the sample matrix and the decomposed dictionary matrix and the sparse coding matrix when the zero norm of the coding vector meets the sparsity constraint ∥sᵢ∥₀≤L . The process is divided into two steps: sparse coding and dictionary updating, and the existing OMP algorithm and KSVD algorithm are used respectively. After completing the above dictionary learning, the dictionary matrix Dᵢ and coding matrix Sᵢ of cooler group i can be obtained.

LS5: after obtaining the dictionary matrix Dᵢ and coding matrix Sᵢ, the sample reconstruction error REᵢ^{k} of cooler group i is calculated according to REᵢ^{k}=∥xᵢ^{k}−Dsₖ∥₂, where sₖ is the k-th coding vector of coding matrix Sᵢ and REᵢ^{k} is the reconstruction error of sample K of cooler group i. The sample reconstruction error REᵢ^{k} reflects the data reconstruction characteristics of the dictionary learning algorithm. When the performance of cooler group i is normal, the sample reconstruction error is small, and when the performance of cooler is degraded, the sample reconstruction error will become larger.

Then, the kernel density estimation method is used to calculate the reconstruction error limit limitᵢ. After obtaining the reconstruction error REᵢ^{k} of each sample in the learning sample set of cooler group i, the bandwidth h is set and the Gaussian kernel function

$$K ( x ) = exp ( {‖ x ‖}^{2} / 2 ) / \sqrt{2 π}$$

is selected as the kernel function K. The probability density distribution function [symbol] (REᵢ) of sample reconstruction error can be calculated according to the following formula:

$$( {RE}_{i} ) = \frac{1}{{N}_{i} h} {\sum }_{k = 1}^{{N}_{i}} K ( \frac{{RE}_{i} - {RE}_{i}^{k}}{h} )$$

Then, the cumulative probability distribution function of sample reconstruction error is calculated:

[symbol] (REᵢ)=∫_{-∞}^{RE}^{ᵢ} [symbol] (t)dt

The confidence is set as αᵢ. According to the cumulative distribution function [symbol] (limitᵢ)≤aᵢ, the sample reconstruction error limit limit; of cooler group i can be calculated, which will be used as the performance early warning index of cooler group i.

LS6: the dictionary matrix Dᵢ, coding matrix Sᵢ and reconstruction error limit limitᵢ of cooler group i are obtained through dictionary learning above, and the dictionary learning result of cooler group i is saved. These parameters will be stored for online early warning calculation.

LS7: the cooler group number is added and the step is turned to LS2 to start the learning and modeling of the next group of coolers.

The offline dictionary learning process exits after all cooler groups are learned.

(3) Online early warning stage

After the offline dictionary learning stage is completed, it can be transferred to the online early warning stage. When the cloud server obtains the real-time operation data of the cooling system from the PLC controller, an online early warning function is called. The online early warning stage is divided into following steps.

AS I : cooler group number i=1 is set. Because there are multiple groups of coolers, similar to the learning stage, the online early warning also adopts circulation to deal with multiple groups of coolers.

AS2: the real-time operation data of the cooling system is taken out from a real-time database to judge whether the cooler group i is in operation, and the processing of the cooler group i is skipped if the cooler group i is not in operation.

AS3: an operation data of sᵢ=1 is selected from the real-time database if the cooler group i is in operation.

AS4: a real-time sample xᵢ^{r} is constituted used to characterize a state of the cooler group i and for subsequent cooler performance monitoring and early warning.

AS5: the dictionary matrix Dᵢ saved in the learning stage is called, and a coding vector sᵢ^{r} is calculated used the OMP algorithm, wherein

$${s}_{i}^{r} = {arg min}_{{s}_{i}^{r}} {‖ {x}_{i}^{r} - {D}_{i} {s}_{i}^{r} ‖}_{2} .$$

AS6: a reconstruction error REᵢ^{r} of the real-time sample xᵢ^{r} is calculated from the coding vector Sᵢ^{r} and the dictionary matrix Dᵢ, where REᵢ^{r}=∥xᵢ^{r}−Dᵢsᵢ^{r}∥₂.

AS7: a relationship between the reconstruction error REᵢ^{r} and the reconstruction error limit limitᵢ, is judged.

AS8: in order to judge the relationship between reconstruction error RE: and reconstruction error limit limit;, an early warning coefficient C_{Ai} is defined: C_{Ai}=(REᵢ^{r-w}>limitᵢ)&, . . . ,&(REᵢ^{r-1}>limitᵢ)&,&(REᵢ^{r}>limitᵢ)

Where, w is a window width of performance warning. When the reconstruction error REᵢ^{r} of continuous w real-time samples is greater than the reconstruction error limit limit,, that is, when C_{Ai} is True, performance warning will be carried out, and when C_{Ai} is False, performance warning will not be carried out.

AS9: the cooler group number is added and the process is transferred to step AS2 to start an early warning processing of the next group of coolers.

The block of the online early warning function exits when all cooler groups of the cooler system are processed, and the online early warning function is called again to complete the real-time performance early warning of the cooling system after a next sampling arrives and is stored in the real-time database.

The above general description of the disclosure involved in the present application and the description of its specific embodiments shall not be construed as a limitation on the technical scheme of the disclosure. According to the disclosure of the application, those skilled in the art can add, reduce or combine the disclosed technical features in the above general description or/and specific implementation mode (including embodiments) without violating the constituent elements of the disclosure, so as to form other technical solutions within the protection scope of the application.

What is claimed is:

1. A cooling system performance early warning method based on dictionary learning, wherein a sensor and an oil pump frequency converter are arranged on a cooler of the cooling system, and the sensor and the oil pump frequency converter are used to measure an operation data of the cooling system; a PLC controller is installed on the cooler to collect the measured operation data; the PLC controller is connected with a cloud server, and the cloud server first performs offline dictionary learning on the data, so as to establish a performance early warning model for each group of coolers respectively; after the offline dictionary learning stage is completed, an online early warning stage is entered, and the established performance early warning model is used to carry out a real-time performance early warning of the cooling system.

2. The cooling system performance early warning method based on dictionary learning of claim 1, wherein the operation data comprises a temperature, a pressure and a flow of the cooler and an output frequency f, of the oil pump frequency converter.

3. The cooling system performance early warning method based on dictionary learning of claim 2, wherein the offline dictionary learning stage comprises:
LS1: setting a cooler group number i=1;
LS2: selecting the operation data of sᵢ=1 from a database, wherein sᵢ=0 indicates that the cooler is in shutdown state, and s,=1 indicates that the cooler is in operation state;
LS3: selecting data from the data obtained in step LS2 to form a learning sample matrix {xᵢ^{k}}ₖ₌₁^{N}^{₁};
LS4: setting dictionary learning parameters, selecting an initial dictionary, starting offline dictionary learning, and obtaining dictionary matrix Dᵢ and coding matrix Sᵢ;
LS5: calculating a sample reconstruction error RE ,' of cooler group i after obtaining the dictionary matrix Dᵢ and the coding matrix Sᵢ, and then calculating a reconstruction error limit limitᵢ;
LS6: saving a dictionary learning result of the cooler group i;
LS7: adding a cooler group number and turning to LS2 to start a learning and modeling of a next group of coolers; and
exiting the offline dictionary learning process after all cooler groups are learned.

4. The cooling system performance early warning method based on dictionary learning of claim 3, wherein operating conditions of cooler group i need to be fully covered when selecting samples, and a sample collection capacity is greater than or equal to 500.

5. The cooling system performance early warning method based on dictionary learning of claim 3, wherein the offline dictionary learning comprises two steps: sparse coding and dictionary updating, and the two steps adopt OMP algorithm and KSVD algorithm respectively.

6. The cooling system performance early warning method based on dictionary learning of claim 3, wherein the reconstruction error limit limit, is calculated by using a kernel density estimation method.

7. The cooling system performance early warning method based on dictionary learning of claim 3, wherein after the offline dictionary learning stage is completed, it can be transferred to the online early warning stage; when the cloud server obtains the real-time operation data of the cooling system from the PLC controller, an online early warning function is called; the online early warning stage is divided into following steps:
AS1: setting cooler group number i=1;
AS2: taking out the real-time operation data of the cooling system from a real-time database to judge whether the cooler group i is in operation; and skipping the processing of the cooler group i if the cooler group i is not in operation;
AS3: selecting an operation data of sᵢ=1 from the real-time database if the cooler group i is in operation;
AS4: constituting a real-time sample xᵢ^{r} used to characterize a state of the cooler group i and for subsequent cooler performance monitoring and early warning;
AS5: calling the dictionary matrix Dᵢ saved in the learning stage, and calculating a coding vector sᵢ^{r} used the OMP algorithm, wherein
$${s}_{i}^{r} = {arg min}_{{s}_{i}^{r}} {‖ {x}_{i}^{r} - {D}_{i} {s}_{i}^{r} ‖}_{2} ;$$
AS6: calculating a reconstruction error REᵢ^{r} of the real-time sample xᵢ^{r} from the coding vector sᵢ^{r} and the dictionary matrix Dᵢ, where REᵢ^{r}=∥xᵢ^{r}−Dsᵣ∥₂;
AS7: judging a relationship between the reconstruction error REᵢ^{r} and the reconstruction error limit limitᵢ;
AS8: indicating that a performance of cooler group i is degraded and needing early warning if the reconstruction error REᵢ^{r} of continuous sampling is greater than the reconstruction error limit limit;
giving no warning if the reconstruction error limit limit, of continuous sampling is less than or equal to the reconstruction error limit limit;;
AS9: adding the cooler group number and going to step AS2 to start an early warning processing of the next group of coolers;
exiting a block of the online early warning function when all cooler groups of the cooler system are processed, and calling the online early warning function again to complete the real-time performance early warning of the cooling system after a next sampling arrives and is stored in the real-time database.

8. The cooling system performance early warning method based on dictionary learning of claim 7, wherein when judging the relationship between reconstruction error REᵢ^{r} and reconstruction error limit limit, an early warning coefficient CA, is defined:
C_{Ai}=(REᵢ^{r-w}>limitᵢ)&, . . . ,&(REᵢ^{r-1}>limitᵢ)&,&(REᵢ^{r}>limitᵢ)
Where, w is a window width of performance warning. When the reconstruction error REᵢ^{r} of continuous w real-time samples is greater than the reconstruction error limit limit, that is, when C_{Ai} is True, performance warning will be carried out, and when C_{Ai} is False, performance warning will not be carried out.

9. The cooling system performance early warning method based on dictionary learning of claim 1, wherein the cloud server is connected with the PLC controller through a NB-IoT module, and after the NB-IoT module obtains the sensor reading from the PLC controller, the NB-IoT module packages and sends the data to the cloud background through MQQT protocol.

10. The cooling system performance early warning method based on dictionary learning of claim 9, wherein the cloud server constructs a service management layer of the Internet of things to complete data storage, management, performance calculation and in-depth analysis; and front-end software such as web page, APP and WeChat applet is a comprehensive application layer of the Internet of things system.
